(19) United States
(12) Patent Application Publication
(10) Pub. No.: US 2023/0205304 A1
(43) Pub. Date: Jun. 29, 2023

(54) PEAK ELECTRICAL CURRENT CONTROL OF SOC OR APU WITH MULTIPLE PROCESSOR CORES AND MULTIPLE GRAPHIC COMPUTE UNITS

(71) Applicant: Advanced Micro Devices, Inc., Santa Clara, CA (US)

(72) Inventors: Xiuting C. Man, Austin, TX (US); Xiaojie He, Austin, TX (US); Michael Leonard Golden, Santa Clara, CA (US); Richard M. Born, Fort Collins, CO (US)

(21) Appl. No.: 17/563,788

(22) Filed: Dec. 28, 2021

(51) Int. Cl. G06F 1/3287; G06F 1/3206

(52) U.S. Cl. CPC G06F 1/3287; G06F 1/3206

(57) ABSTRACT

A system and method for efficient power management of an integrated circuit are described. In various implementations, a computing system includes an integrated circuit, multiple voltage regulators, and circuitry that detects when current drawn from a power rail from one of the multiple voltage regulators exceeds a limit. Upon detection, a single global alarm signal is asserted and conveyed to the integrate circuit. The integrated circuit includes at least a first group of functional blocks sharing a first power rail and a second group of functional blocks sharing a second power rail. When the global alarm signal is asserted, the functional blocks of the first group and the second group perform steps to immediately reduce power consumption. In order to maintain performance and satisfy a quality of service (QoS) parameter, a power management controller of the integrated circuit reassigns power limits shortly thereafter.

### BACKGROUND

### Description of the Relevant Art

The power consumption of modern integrated circuits has become an increasing design issue with each generation of semiconductor chips. As power consumption increases, more costly cooling systems are utilized to remove excess heat and prevent failure of the integrated circuit. Examples of the costly cooling systems are larger fans, larger heat sinks, and systems to control ambient temperature. Managing power consumption is not only an issue for portable computers and mobile communication devices, but also for high-performance superscalar microprocessors used in desktop and server systems.

In order to manage power consumption, an integrated circuit typically uses a centralized power management system that can cause one or more functional blocks to enter and exit one or more idle or sleep states. The power management system may also be able to cause active functional blocks to enter one or more power-performance states (P-states). A waking up period is associated with returning to an active state from an idle or sleep state. Additionally, a selected P-state affects multiple functional blocks when multiple functional blocks share a power rail. Therefore, the performance of the integrated circuit may be reduced for many reasons when typical steps are performed to reduce power consumption. Consequently, it is possible that the integrated circuit is no longer able to satisfy a required, or desired, quality of service (QoS).

In view of the above, efficient methods and mechanisms for efficient power management of an integrated circuit are desired.

### BRIEF DESCRIPTION OF THE DRAWINGS

FIG. 1 is a generalized diagram of a computing system.

FIG. 2 is a generalized diagram of a power management controller.

FIG. 3 is a generalized diagram of one embodiment of a method for efficiently managing power consumption of an integrated circuit.

FIG. 4 is a generalized diagram of another embodiment of a method for efficiently managing power consumption of an integrated circuit.

FIG. 5 is a generalized diagram of one embodiment of a method for efficiently managing power consumption of an integrated circuit.

FIG. 6 is a generalized diagram of one embodiment of a method for efficiently managing power consumption of an integrated circuit.

FIG. 7 is a generalized diagram of one embodiment of a method for efficiently managing power consumption of an integrated circuit.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Systems and methods for efficient power management of an integrated circuit are contemplated. In various implementations, a computing system includes an integrated circuit, such as a system on a chip (SoC), an accelerated processing unit (APU) that includes a central processing unit (CPU) and a graphics processing unit (GPU), or other. The integrated circuit includes at least a first group of functional blocks sharing a first power rail and a second group of functional blocks sharing a second power rail. In each group, the functional blocks can have homogeneous or heterogeneous functional subgroups. In one APU or SoC example, a CPU and GPU can be placed in the same group such that they share the same power supply. In another APU or SoC example, CPU and GPU can be placed in different groups such that they have different power supplies. In another SoC example, processing units of types other than CPU or GPU, such as but not limited to inference accelerators, coprocessing units, can be placed within the same or different group as CPU or GPU. The first group and the second group of functional blocks process tasks. The computing system includes a first voltage regulator that provides a first power supply voltage level on the first power rail, and a second voltage regulator that provides a second power supply voltage level on the second power rail.

The computing system includes circuitry that monitors power consumption by the first group and the second group. In some implementations, this circuitry monitors a first amount of current drawn from the first power rail by the first group of functional blocks, and monitors a second amount of current drawn from the second power rail by the second group of functional blocks. This monitoring circuitry can be placed in one of multiple locations, such as in a power manager located externally from the integrated circuit, in one of the first and second voltage regulators, in a separate control unit, or otherwise. In order to reduce the number of external pins and the size of the internal interconnect network required to implement the integrated circuit, this circuitry that monitors the current being drawn sends a single global alarm signal to the integrated circuit. The single global alarm signal is used to indicate whether one or more of the first group and the second group has exceeded a respective current or power limit. Therefore, although in an implementation, there are two power rails, the circuitry uses the single global alarm signal to communicate with the integrated circuit regarding a current or power consumption violation by one or more of the first group and the second group.

The integrated circuit also includes a power management controller that assigns and sends a first set of power limits to the first group of functional blocks and a second set of power limits to the second group of functional blocks. The power management controller generates these assignments based on one or more of reported power consumption of the first group and the second group, a determined type of work load, a determined range of types of workloads, a detection that a particular time interval has elapsed, and the global alarm signal. In some implementations, the integrated circuit receives the single global alarm signal and routes this signal to the power management controller and the first group and the second group of functional blocks.

When the received global alarm signal is negated, the functional blocks of the first group and the second group perform power reducing steps to maintain peak power consumption to no greater than a corresponding power limit of the assigned sets of power limits. Conversely, when the received global alarm signal is asserted, the functional blocks of the first group and the second group perform power reducing steps to reduce peak power consumption to a level that is lower than a power limit (e.g., a fraction of the corresponding power limit of the assigned sets of power limits). Such a fraction is a positive, non-zero ratio less than one. For example, the fraction may be one half, one fourth, or some other value. In some implementations, while the global alarm signal continues to be asserted, this faction is adaptively reduced over time. For example, it may be reduced at predetermined time internals, or dynamically based on other events or conditions. It is noted that in some implementations it is unknown which functional blocks of the first group and the second group are drawing sufficient current to cause assertion of the global alarm signal. Nevertheless, the power reducing steps by each of the functional blocks aid in removing the relatively high power consumption condition caused by the integrated circuit.

In addition to the above, when the global alarm signal is asserted, the power management controller requests the first group and the second group report power consumption values. With the reported power consumption values, the power management controller re-evaluates the distribution of a power budget across first group and the second group, and then reassigns power limits. The power management controller determines the reassigned power limits in a manner to provision more of the power budget to functional blocks where higher performance is needed to satisfy a quality of service (QoS) parameter while also maintaining at predetermined limits the current drawn from the first power rail and the second power rail. The power management controller also determines the reassigned power limits in a manner to provision less of the power budget to functional blocks where higher performance is not needed to satisfy the QoS parameter. The power management controller sends the reassigned (updated) power limits to the functional blocks. The functional blocks use the received updated power limits when the received global alarm signal becomes negated. In the meantime, the functional blocks continue to reduce local power consumption using the fraction of the current corresponding power limit. Therefore, when the single global alarm signal is asserted, although it is initially unknown which functional blocks of the first group and the second group caused the power consumption violation of the integrated circuit, each of the functional blocks perform immediate steps to reduce power consumption. In order to maintain performance and satisfy the quality of service (QoS) parameter, at a later time, the power management controller reassigns power limits based on reevaluation using the QoS parameter, the limits on the amounts of current drawn from the power rails, and the reported power consumption values from the functional blocks of the first group and the second group.

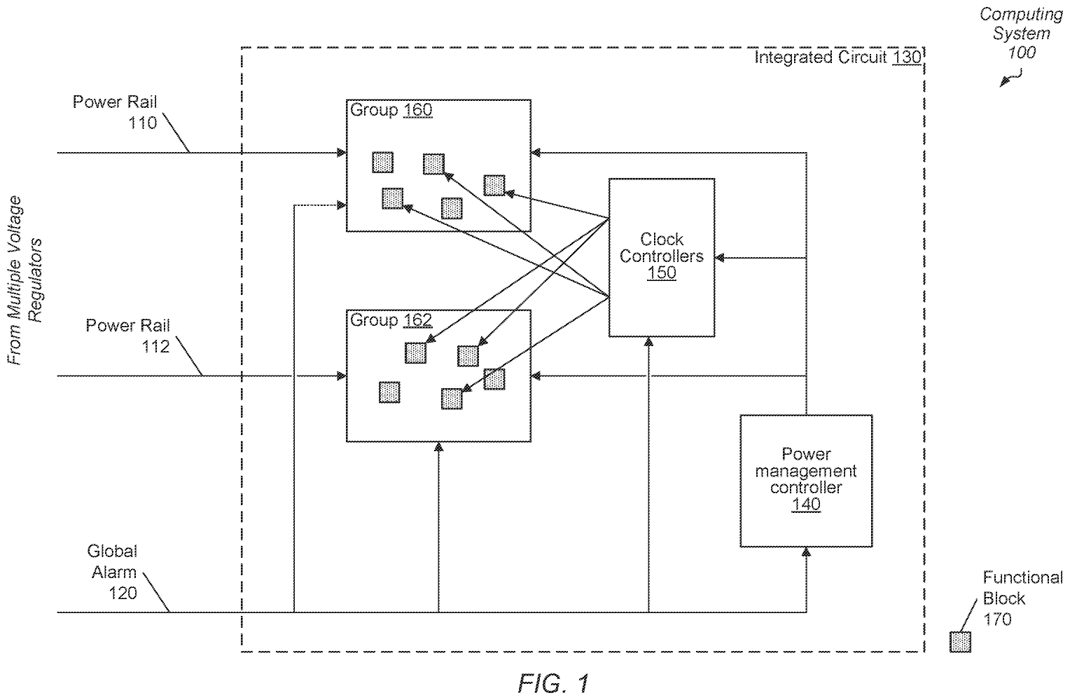

Turning now to FIG. 1, a generalized block diagram of a computing system 100 is shown. In various implementations, the computing system 100 includes an integrated circuit 130 that receives multiple power rails such as power rails 110 and 112. Examples of the integrated circuit 130 are a system on a chip (SoC), an accelerated processing unit (APU) that includes a central processing unit (CPU) and a graphics processing unit (GPU), or other. Although two power rails are shown, the integrated circuit 130 uses another number of power rails in other implementations. Similarly, although a single integrated circuit is shown, the computing system 100 uses another number of integrated circuits in other implementations. The integrated circuit 130 includes a power management controller 140, clock controllers 150 and groups 160-162 of functional blocks 170. Each of the groups 160-162 receives a respective one of the power rails 110-112.

Although the functional blocks 170 are shown as being similar, the functional blocks 170 can have different functionalities such as one functional block is a cache controller and another functional block is a single processor core of multiple cores on a CPU or a compute unit of multiple compute units on a GPU. In some implementations, the integrated circuit 130 is an individual die of multiple dies on a system-on-a-chip (SOC). This implementation does not include all examples of components of the integrated circuit 130 such as a system bus or communication fabric, interface units, cache controllers, and so forth. The implementation shown is for a simple illustrative purpose.

In some implementations, a separate first voltage regulator provides a first power supply voltage level on the power rail 110, and a second voltage regulator provides a different, second power supply voltage level on the power rail 112. In other embodiments, a single external voltage regulator provides different power supply voltage levels on the power rails 110-112. The group 160 of functional blocks 170 shares the power rail 110 and the group 162 of functional blocks 170 shares the power rail 112. The functional blocks 170 of the groups 160-162 process tasks assigned to them.

In various implementations, the functional blocks 170 are capable of monitoring local power consumption. For example, the power management controller 140 assigns power limits to the functional blocks 170. In some implementations, the power management controller 140 assigns power credits to the functional blocks 170. In other implementations, the power management controller 140 assigns limits on an amount of current draw, limits on power consumed (e.g., 1,000 watts), or other. The power management controller 140 generates these assignments based on one or more of reported power consumption of the groups 160-162, a type of work load, a detection that a particular time interval has elapsed, and the global alarm signal 120.

One or more of the external voltage regulators and a control unit includes circuitry that monitors power consumption by the group 160 and the group 162. In some implementations, this circuitry monitors a first amount of current drawn from the power rail 110 by the group 160, and monitors a second amount of current drawn from the power rail 112 by the group 162. In order to reduce a number of pins and the required interconnect network of the integrated, a single global alarm signal 120 is used to indicate whether one or more of the groups 160-162 has exceeded a respective power limit. This power limit is different from the power limits assigned by the power management controller 140, and this power limit indicates that the computing system 100 is nearing operating failure. Although there are at least two power rails 110-112, the circuitry uses the single global alarm signal 120 to communicate with the integrated circuit 130 regarding a power consumption violation by either of the groups 160-162. In some implementations, the integrated circuit 130 receives the single global alarm signal 120 and routes this signal to the power management controller 140 and the groups 160-162.

When the received global alarm signal 120 is negated, the functional blocks 170 of the groups 160-162 perform power reducing steps to maintain peak power consumption equal to or less than a corresponding power limit of the assigned sets of power limits from the power management controller 140. However, when the received global alarm signal 120 is asserted, the functional blocks 170 of the groups 160-162 perform additional power reducing steps to reduce peak power consumption equal to or less than a fraction of a corresponding power limit of the assigned sets of power limits. The fraction is a positive, non-zero ratio less than one. For example, the fraction is one half, one fourth, or other. Additionally, the power management controller 140 requests the functional blocks 170 of the groups 160-162 report power consumption values, and then reassigns power limits. Therefore, when the single global alarm signal 120 is asserted, although it is unknown which functional blocks 170 of the groups 160-162 caused the power consumption violation, each of the functional blocks 170 perform immediate steps to reduce power consumption. In order to maintain performance and satisfy a quality of service (QoS) parameter, the power management controller 140 reassigns power limits shortly thereafter.

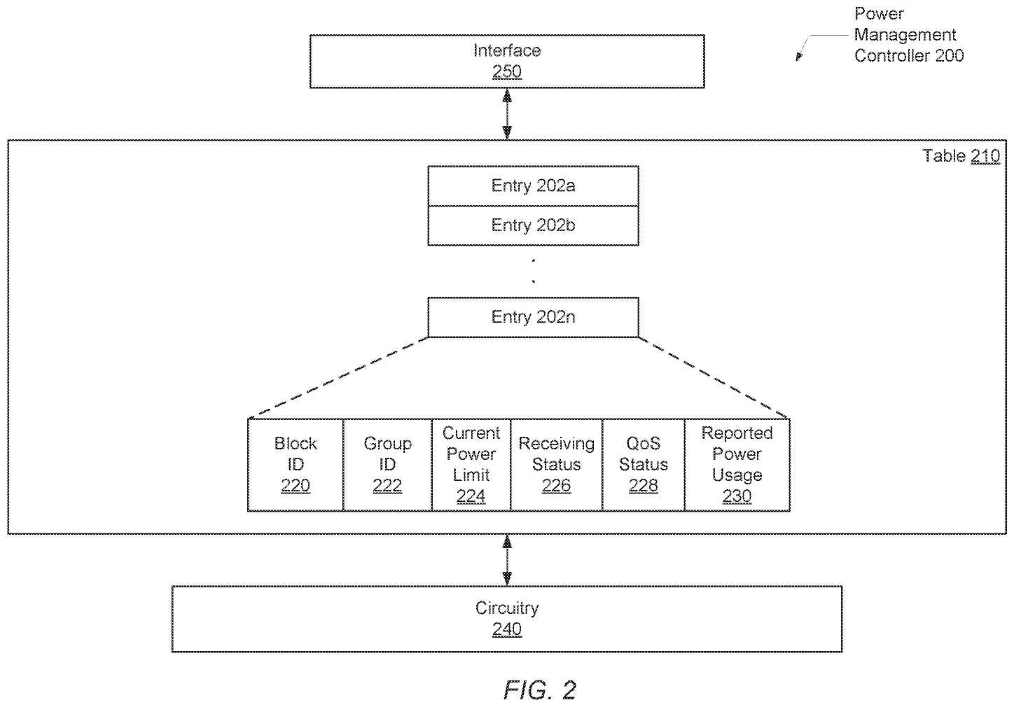

Referring to FIG. 2, a generalized block diagram of a power management controller 200 is shown. The power management controller 200 (or controller 200) includes an interface 250, a table 210 and circuitry 240. The interface 250 communicates with groups of functional blocks across an integrated circuit. For example, requests for power consumption data and responses with the requested data transfer through interface 250. The interface 250 includes one or more data storage queues for storing requests and responses. The interface 250 also includes circuitry for generating packets according to any formats supported by an external communication fabric. Additionally, the interface 250 includes circuitry for decoding any received packets. When requested power consumption values are received, one or more of the interface 250 and the circuitry 240 updates entries of the table 210.

The table 210 includes multiple entries 202a-202n. The table is implemented as rows of flip-flops, as one of a variety of random access memories (RAMs), as a content addressable memory (CAM), or other. In some implementations, the table 210 includes a separate entry for each of the functional blocks in the integrated circuit. Each one of the entries 502a-502n includes multiple fields 220-230 as shown in FIG. 2. Although the fields 520-538 are shown in this particular order, other combinations are possible and other or additional fields may be utilized as well. The bits storing information for the fields 220-230 are not always contiguous.

Field 220 stores an indication of a block identifier (ID) that distinguishes the functional block from other functional blocks of a same group that shares a same power rail. Field 222 stores an indication of a group identifier (ID) that identifies the group of functional blocks sharing a same power rail. Field 224 stores a current power limit value for the functional block. This value is represented as a number of power credits, a measure of power consumption (e.g., 1,000 watts), or other. Field 226 of table 210 stores an indication of whether a corresponding functional block is receiving power credits or donating power credits. In an implementation, field 226 also stores a number of corresponding power credits (or a number of watts) that are received or donated.

Field 228 stores an indication specifying whether the corresponding functional block is able to help maintain a quality of service (QoS) parameter. This indication depends on the type of workload being processed in addition to the functionality of the functional block. This indication is also used as a priority when the circuitry 240 reassigns power limits for the functional blocks. Field 230 stores a requested power usage of the functional block. For example, when the controller 200 receives an asserted global alarm signal via the interface 250, the controller requests the current power usage of the functional blocks. When the requested data is returned, this data is stored in field 230. It is possible and contemplated that the table 210 uses other fields that store a variety of other types of information used by the circuitry 240 for power management of the integrated circuit.

The circuitry 240 performs comparison operations such as comparing reported power usage of functional blocks to corresponding threshold values. In addition, the circuitry 540 determines updated power limits for the functional blocks. The circuitry 240, in some implementations, also includes one or more times to measure elapsed time since a last update of power limits.

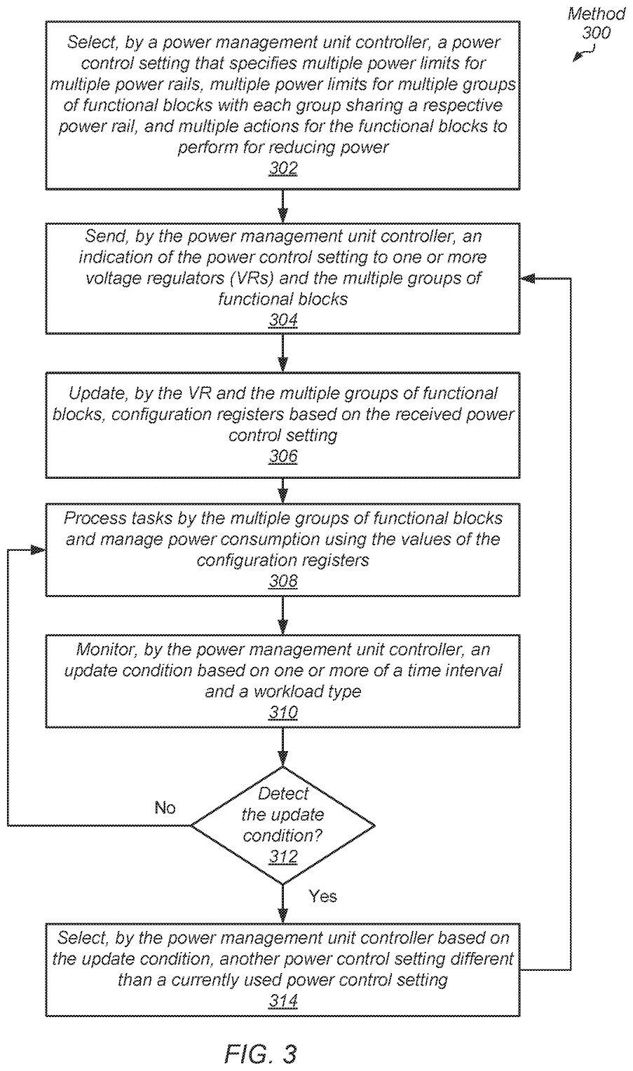

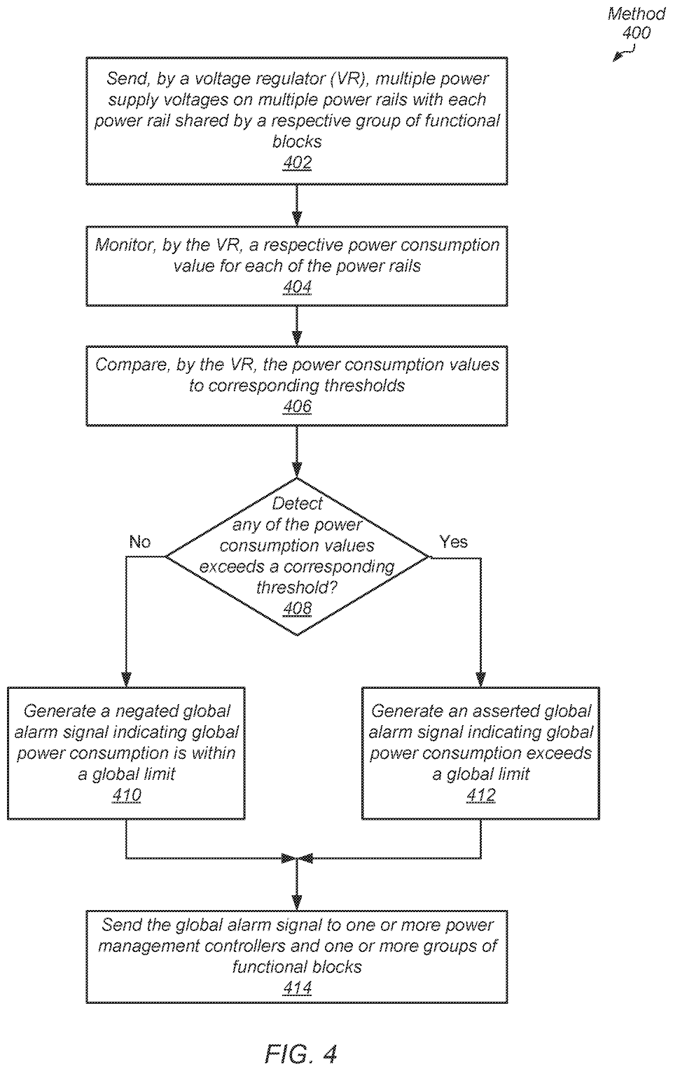

Turning now to FIG. 3, one embodiment of a method 300 for efficiently managing power consumption of an integrated circuit is shown. For purposes of discussion, the steps in this embodiment (as well as in FIGS. 4-5 and 7-8) are shown in sequential order. However, in other embodiments some steps occur in a different order than shown, some steps are performed concurrently, some steps are combined with other steps, and some steps are absent.

A power management controller selects a power control setting that specifies multiple power limits for multiple power rails, multiple power limits for multiple groups of functional blocks with each group sharing a respective power rail, and multiple actions for the functional blocks to perform for reducing power (block 302). In various implementations, an integrated circuit includes the power management controller. Examples of the integrated circuit are a system on a chip (SoC), an accelerated processing unit (APU) that includes a central processing unit (CPU) and a graphics processing unit (GPU), a separate CPU, a separate GPU, or other. In other implementations, an external power management unit (PMU) controls multiple components such as the integrated circuit, a communication fabric, another integrated circuit, an input/output interface unit, and so on. In such an implementation, the PMU selects the power control setting, and sends an indication of the power control setting to the power management controller.

The power management controller sends an indication of the power control setting to one or more voltage regulators (VRs) and the multiple groups of functional blocks (block 304). The one or more VRs and the multiple groups of functional blocks update configuration registers based on the received power control setting (block 306). When the one or more VRs update configuration registers, one or more of the power supply voltage levels on corresponding power rails are updated to new values. Additionally, the one or more VRs adjust power limit values used as power thresholds to compare to a measured power limit. In some implementations, a particular power limit is a measurement of an amount of current drawn from a particular power rail shared by a group of functional blocks of the integrated circuit. Therefore, the power thresholds are a set of thresholds, one for each possible voltage level that can be driven on the particular power rail.

When the functional blocks update configuration registers, the functional blocks also update power thresholds, but these thresholds are based on an assigned amount of power allotted to each functional block. For example, the power management controller assigns power credits to the functional blocks. In addition, one or more of the power management controller and a particular functional block has actions permitted or prevented regarding power management. In one example, the power management controller sends an indication to the particular functional block preventing the use of clock gating or using an idle state due to workload behavior detected by the power management controller.

The multiple groups of functional blocks process tasks and manage power consumption using the values of the configuration registers (block 308). The power management controller monitors an update condition based on one or more of a time interval and a workload type (block 310). For example, the power management controller measures elapsed time since a last update and compares the measured elapsed time to a time threshold. Additionally, the power management controller is able to receive a global alarm signal from an external control unit or any one of the VRs. In some implementations, the integrated circuit receives the single global alarm signal and routes this signal to the power management controller and groups of functional blocks. When asserted, the single global alarm signal indicates one or more of the groups of functional blocks has exceeded a respective power limit.

If the power management controller of the integrated circuit does not detect the update condition (“no” branch of the conditional block 312), then control flow of method 300 returns to block 308 where multiple groups of functional blocks process tasks and manage power consumption using the values of the configuration registers. However, if the power management controller of the integrated circuit detects the update condition (“yes” branch of the conditional block 312), then the power management unit controller selects, based on the update condition, another power control setting different than a currently used power control setting (block 314). For example, the power management unit controller determines the next power control setting based on one or more of current workload behavior, a quality of service (QoS) parameter, reported power values or credits of the functional blocks, the current voltage levels of the power rails, the measurement of the elapsed time, and so on.

Referring to FIG. 4, one embodiment of a method 400 for efficiently managing power consumption of an integrated circuit is shown. A voltage regulator (VR) sends multiple power supply voltages on multiple power rails with each power rail shared by a respective group of functional blocks (block 402). The VR monitors a respective power consumption value for each of the power rails (block 404). In an implementation, the VR measures an amount of current being drawn on a power rail. In other implementations, an external control unit performs the measurement and reports the result. The VR compares the power consumption values to corresponding thresholds (block 406). The threshold values are based on the current power supply voltage levels on the power rails. The product of the power supply voltage level and the amount of current being drawn indicates the power consumption.

If the VR or another control unit determines no power consumption value exceeds a corresponding threshold (“no” branch of the conditional block 408), then the VR or control unit generates a negated global alarm signal indicating global power consumption is within a global limit (block 410). Otherwise, if the VR or control unit determines one or more power consumption values exceed a corresponding threshold (“yes” branch of the conditional block 408), then the VR or control unit generates an asserted global alarm signal indicating global power consumption is within a global limit (block 412). The VR or control unit sends the global alarm signal to one or more power management controllers and one or more groups of functional blocks (block 414). For example, interface circuitry of the integrated circuit receives the global alarm signal and routes this signal to a power management controller and the groups of functional blocks.

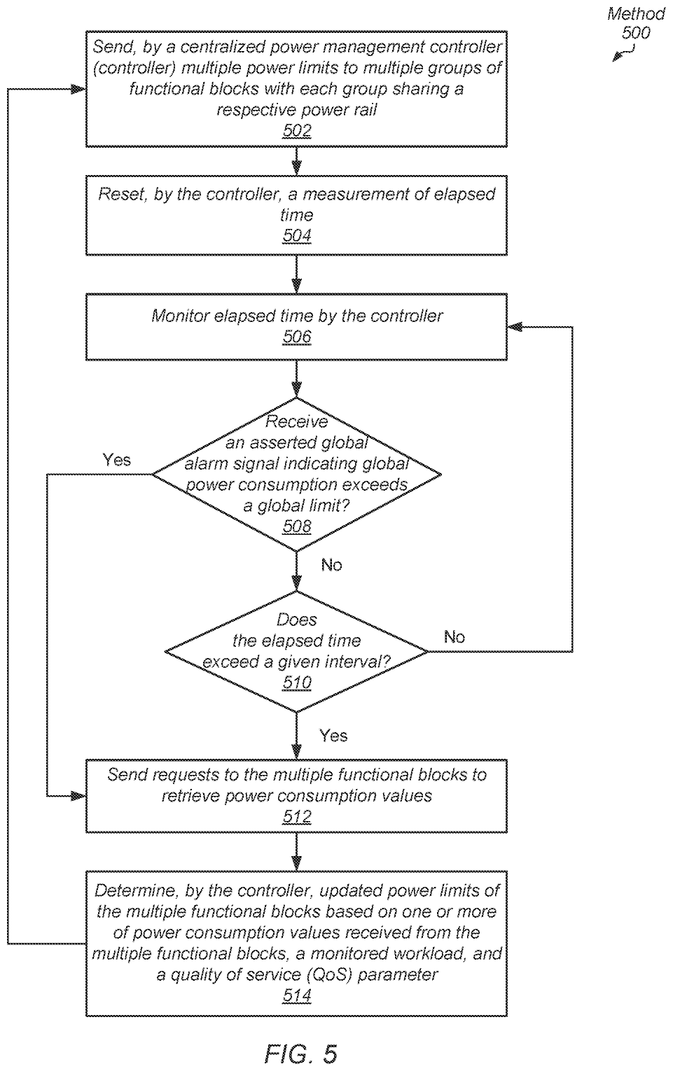

Turning now to FIG. 5, one embodiment of a method 500 for efficiently managing power consumption of an integrated circuit is shown. A centralized power management controller of an integrated circuit sends multiple power limits to multiple groups of functional blocks with each group sharing a respective power rail (block 502). Examples of the integrated circuit are a CPU, a GPU, an APU, a SoC, an application specific integrated circuit (ASIC), a digital signal processor (DSP), or other. The power limits include one or more of an amount of power credits, an amount of power consumption, or other. The power management controller resets a measurement of elapsed time (block 504), and monitors the elapsed time (block 506).

The power management controller is capable of receiving a global alarm signal that indicates whether global power consumption by the groups of functional blocks exceeds a global power limit. If the power management controller does not receive an asserted global alarm signal (“no” branch of the conditional block 508), and the power management controller does not determine the elapsed time has exceeded a given interval (“no” branch of the conditional block 510), then control flow of method 500 returns to block 506 where the power management controller continues to monitor the elapsed time while the groups of functional blocks process tasks.

If the power management controller receives an asserted global alarm signal (“yes” branch of the conditional block 508), then the power management controller sends requests to the multiple functional blocks to retrieve power consumption values (block 512). These requests are similar to a broadcast requesting the groups of functional blocks to report power consumption data. Similarly, if the power management controller does not receive an asserted global alarm signal (“no” branch of the conditional block 508), but the power management controller determines the elapsed time has exceeded a given interval (“yes” branch of the conditional block 510), then the power management controller sends requests to the multiple functional blocks to retrieve power consumption values (block 512).

The power management controller updates power limits of the groups of functional blocks based on one or more of power consumption values received from the multiple functional blocks, a monitored workload, a quality of service (QoS) parameter, and so forth. Afterward, the control flow of method 500 returns to block 502 where the power management controller sends the power limits to the groups of functional blocks.

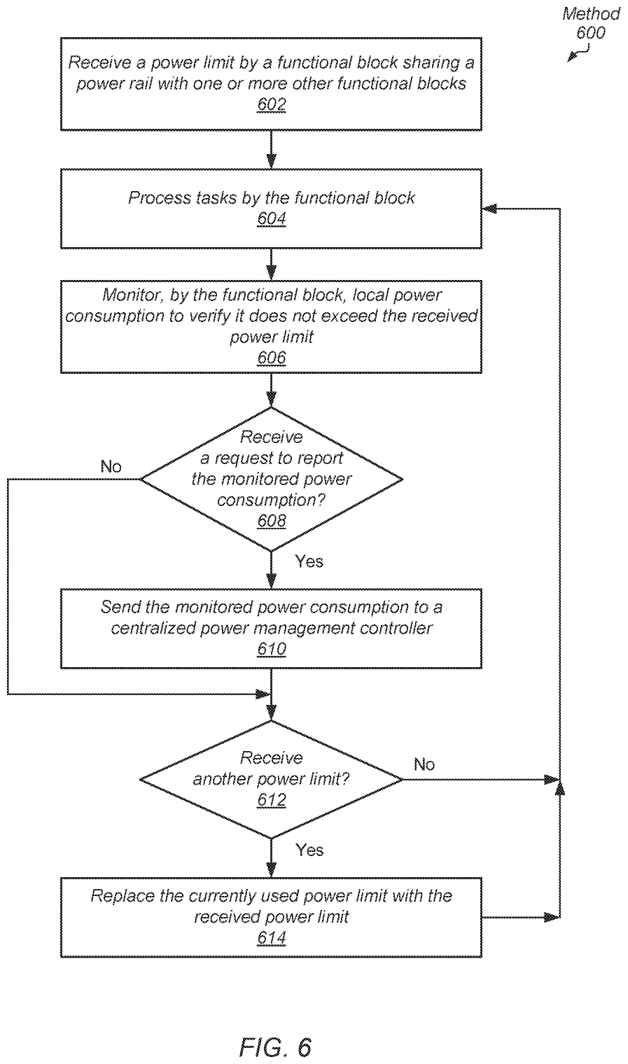

Turning now to FIG. 6, one embodiment of a method 600 for efficiently managing power consumption of an integrated circuit is shown. A functional block sharing a power rail with one or more other functional blocks receives a power limit (block 602). The functional block processes tasks based on the received power limit (block 604). For example, when the power limit is a number of power credits, the functional block does not operate with an activity level that causes the functional block to exceed the assigned number of power credits. For example, the functional block monitors local power consumption to verify it does not exceed the received power limit (block 606).

If the functional block receives a request to report the monitored power consumption (“yes” branch of the conditional block 608), then the functional block sends the monitored power consumption to a centralized power management controller (block 610). For example, the request is part of a broadcast request by the power management controller due to the power management controller receiving an asserted global alarm signal. Alternatively, the power management controller detected that a given interval has elapsed since a previous update of power limits. If the functional block receives another power limit (“yes” branch of the conditional block 612), then the functional block replaces the currently used power limit with the received power limit (block 614). Afterward, control flow of method 600 returns to block 604 where the functional block processes tasks.

If the functional block does not receive a request to report the monitored power consumption (“no” branch of the conditional block 608), or the functional block does not receive another power limit (“no” branch of the conditional block 612), then control flow of method 600 returns to block 604 where the functional block processes tasks.

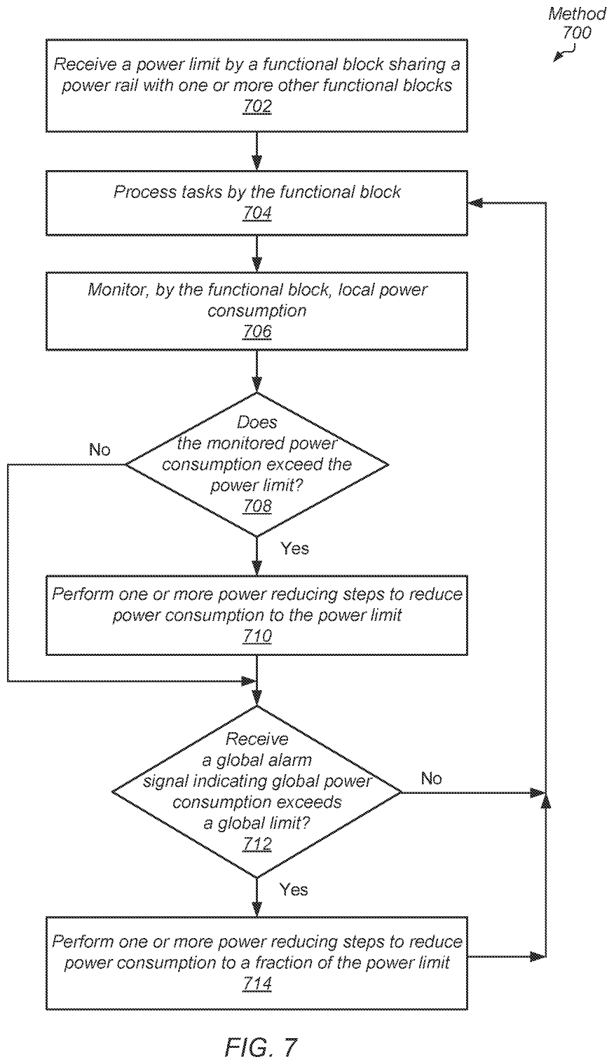

Referring now to FIG. 7, one embodiment of a method 700 for efficiently managing power consumption of an integrated circuit is shown. A functional block sharing a power rail with one or more other functional blocks receives a power limit (block 702). The functional block processes tasks based on the received power limit (block 704). For example, when the power limit is a number of power credits, the functional block does not operate with an activity level that causes the functional block to exceed the assigned number of power credits. For example, the functional block monitors local power consumption to verify it does not exceed the received power limit (block 706).

Real-time power estimation is achieved when measuring the switching capacitance on a die during a particular clock cycle. A node capacitance, CAC, includes the switched, or alternating current (AC), capacitance. For example, the power consumption of integrated circuits, such as modern complementary metal oxide semiconductor (CMOS) chips, is proportional to the expression αfCV². The symbol a is the switching factor, or the probability a node will charge up or discharge during a clock cycle. The symbol f is the operational frequency of the chip. The symbol C is the equivalent capacitance, or the switching capacitance, to be charged or discharged in a clock cycle. The symbol V is the operational voltage of the chip. Real-time power estimation is achieved when measuring the switching capacitance on a die during a particular clock cycle. A node capacitance, CAC, includes the switched, or alternating current (AC), capacitance. In some implementations, the functional block monitors a subset of its node signals whose assertion correlates with an appreciable amount of switched capacitance. These signals are indicated as node capacitance (CAC) signals. Examples of such node signals are clock enable signals, bus driver enable signals, signals that indicate look-up operations in content-addressable memories (CAM), and output signals of CAM word-line (WL) drivers. In an implementation, the functional block uses counters that track when these nodes are used during the processing of tasks. The counts are translated to a value that indicates power consumption of the functional block.

If the monitored power consumption exceeds the power limit (“yes” branch of the conditional block 708), then the functional block performs one or more power reducing steps to reduce power consumption to the power limit (block 710). If the functional block receives a global alarm signal indicating global power consumption exceeds a global limit (“yes” branch of the conditional block 708), then the functional block performs one or more power reducing steps to reduce power consumption to a fraction of the power limit (block 714). These steps are more severe than the previous steps. For example, if the functional block has a power limit equivalent to 1,000 watts, and the functional block determines the local power consumption exceeds this limit, the functional block takes steps to return the local power consumption to 1,000 watts. Alternatively, the functional block performs steps to reduce the local power consumption to 950 watts, or some value near the power limit of 1,000 watts.

However, if the functional block receives the asserted global alarm signal, then the functional block performs steps to reduce the local power consumption to 500 watts or 200 watts. In other words, the functional block reduces its peak power consumption to a level that is a fraction of its power limit. This fraction is a positive, non-zero ratio less than one. For example, the fraction is one half, one fourth, or other. In some implementations, while the global alarm signal continues to be asserted, this faction is adaptively reduced at each predetermined or dynamically adjustable time internal to a smaller, updated fraction. In various implementations, while the global alarm signal continues to be asserted, the functional block continues maintaining its peak power consumption to a fraction of its power limit. Afterward, control flow of method 700 returns to block 704 where the functional block processes tasks. If the functional block does not determine the monitored power consumption exceeds the power limit (“no” branch of the conditional block 708), or the functional block does not receive the asserted global alarm signal (“no” branch of the conditional block 712), then control flow of method 700 returns to block 704 where the functional block processes tasks. It is noted that when control flow of method 700 moves from conditional block 712 to block 704 (“no” branch of the conditional block 712), the functional block begins using a new power limit if a new, updated power limit is received from the power management controller.

It is noted that one or more of the above-described embodiments include software. In such embodiments, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various embodiments, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a power management controller configured to send a first power limit to a first group of functional blocks and a second power limit to a second group of functional blocks;
wherein in response to detection of an asserted global alarm signal indicating power consumption of the apparatus has exceeded a global limit:
one or more functional blocks, of the first group of functional blocks, are configured to reduce power consumption to a fraction of the first power limit; and
one or more functional blocks, of the second group of functional blocks, are configured to reduce power consumption to a fraction of the second power limit.

2. The apparatus as recited in claim 1, wherein the first group of functional blocks share a first power rail, and the second group of functional blocks share a second power rail, and wherein the power consumption exceeding the global limit is based on one or more of:
a power limit of the first power rail has been exceeded; and
a power limit of the second power rail has been exceeded.

3. The apparatus as recited in claim 1, wherein one or more functional blocks of either the first group of functional blocks or the second group of functional blocks are configured to reduce power consumption to a corresponding one of the first power limit and the second power limit, in response to:
determining a monitored power consumption exceeds a corresponding one of the first power limit and the second power limit; and
determining the global alarm signal is negated.

4. The apparatus as recited in claim 1, wherein in response to detecting the asserted global alarm signal indicating power consumption of the apparatus has exceeded the global limit, the power management controller is configured to:
send a plurality of requests to retrieve power consumption values from one or more of the first group of functional blocks and the second group of functional blocks.

5. The apparatus as recited in claim 4, wherein the power management controller is further configured to send the plurality of requests, in response to determining a monitored elapsed time exceeds a given time interval.

6. The apparatus as recited in claim 4, wherein the power management controller is further configured to:
determine updated limits of the first power limit and the second power limit based on the power consumption values received from the first group of functional blocks and the second group of functional blocks; and
send the updated limits to the first group of functional blocks and the second group of functional blocks.

7. The apparatus as recited in claim 6, wherein the power management controller is further configured to determine updated limits of the first power limit and the second power limit based on one or more of a monitored work load and a quality of service (QoS) parameter.

8. A method comprising:
sending, by a power management controller, a first power limit to a first group of functional blocks and a second power limit to a second group of functional blocks;
in response to detecting an asserted global alarm signal indicating power consumption of the apparatus has exceeded a global limit:
reducing, by one or more functional blocks of the first group, power consumption to a fraction of the first power limit; and
reducing, by one or more functional blocks of the second group, power consumption to a fraction of the second power limit.

9. The method as recited in claim 8, wherein the first group of functional blocks share a first power rail, and the second group of functional blocks share a second power rail, and wherein the power consumption of the apparatus exceeds the global limit based on one or more of:
a first power limit of the first power rail has been exceeded; and
a second power limit of the second power rail has been exceeded.

10. The method as recited in claim 8, further comprising reducing, by one or more functional blocks of either the first group of functional blocks or the second group of functional blocks, power consumption to a corresponding one of the first power limit and the second power limit, in response to:
determining a monitored power consumption exceeds a corresponding one of the first power limit and the second power limit; and
determining the global alarm signal is negated.

11. The method as recited in claim 8, wherein in response to detecting the asserted global alarm signal indicating power consumption of the apparatus has exceeded the global limit, the method further comprises:
sending, by the power management controller, a plurality of requests to retrieve power consumption values from one or more of the first group of functional blocks and the second group of functional blocks.

12. The method as recited in claim 11, further comprising sending, by the power management controller, the plurality of requests, in response to determining a monitored elapsed time exceeds a given time interval.

13. The method as recited in claim 11, further comprising:
determining, by the power management controller, updated limits of the first power limit and the second power limit based on the power consumption values received from the first group of functional blocks and the second group of functional blocks; and
sending, by the power management controller, the updated limits to the first group and the second group.

14. The method as recited in claim 13, further comprising determining, by the power management controller, updated limits of the first power limit and the second power limit based on one or more of a monitored work load and a quality of service (QoS) parameter.

15. A computing system comprising:
a first voltage regulator configured to provide a first power supply voltage level on a first power rail;
a second voltage regulator configured to provide a second power supply voltage level on a second power rail; and
an integrated circuit configured to utilize each of the first power rail and the second power rail, wherein the integrated circuit comprises:
a first group of functional blocks;
a second group of functional blocks; and
a power management controller configured to send a first power limit to the first group of functional blocks and a second first power limit to the second group of functional blocks;
wherein in response to receiving an asserted global alarm signal indicating power consumption of the apparatus has exceeded a global limit:
one or more functional blocks, of the first group of functional blocks, are configured to reduce power consumption to a fraction of the first power limit; and
one or more functional blocks, of the second group of functional blocks, are configured to reduce power consumption to a fraction of the second power limit.

16. The computing system as recited in claim 15, wherein the first group of functional blocks share a first power rail, and the second group of functional blocks share a second power rail, and wherein the power consumption exceeding the global limit is based on one or more of:
a power limit of the first power rail has been exceeded; and
a power limit of the second power rail has been exceeded.

17. The computing system as recited in claim 15, wherein one or more functional blocks of either the first group of functional blocks or the second group of functional blocks are configured to reduce power consumption to a corresponding one of the first power limit and the second power limit, in response to:
determining a monitored power consumption exceeds a corresponding one of the first power limit and the second power limit; and
determining the global alarm signal is negated.

18. The computing system as recited in claim 15, wherein in response to receiving the asserted global alarm signal indicating power consumption of the apparatus has exceeded the global limit, the power management controller is configured to:
send a plurality of requests to retrieve power consumption values from one or more of the first group of functional blocks and the second group of functional blocks.

19. The computing system as recited in claim 18, wherein the power management controller is further configured to send the plurality of requests, in response to determining a monitored elapsed time exceeds a given time interval.

20. The computing system as recited in claim 18, wherein the power management controller is further configured to:
determine updated limits of the first power limit and the second power limit based on the power consumption values received from the first group of functional blocks and the second group of functional blocks; and
send the updated limits to the first group of functional blocks and the second group of functional blocks.
